(19) United States
(12) Patent Application Publication
(10) Pub. No.: US 2013/0007862 A1
(43) Pub. Date: Jan. 3, 2013

(54) METHOD AND SYSTEM FOR NETWORK AVAILABILITY ALERT

(75) Inventor: Scott Kincaid, Walnut Creek, CA (US)

(73) Assignee: Salesforce.com Inc., San Francisco, CA (US)

(21) Appl. No.: 13/275,164

(22) Filed: Oct. 17, 2011

Related U.S. Application Data
(60) Provisional application No. 61/503,744, filed on Jul. 1, 2011.

(51) Int. Cl. G06F 15/173; G06F 21/20; H04L 9/32

(52) U.S. Cl. 726/7; 709/224

(57) ABSTRACT

In accordance with embodiments, there are provided mechanisms and methods for providing a network availability alert to a user in an on-demand service. These mechanisms and methods for providing a network availability alert to a user in an on-demand service may enable embodiments to provide a user with the knowledge that the connectivity problem is not the fault of the on-demand service. In this way the user may be provided with information that best allows the user to obtain connectivity.

### CLAIM OF PRIORITY

This application claims the priority benefit of U.S. Provisional Patent Application 60/503,744 entitled, “Method and System for Network Availability Alert,” by Scott Kincaid, filed Jul. 1, 2011 (Attorney Docket No. 649PROV), the entire contents of which are incorporated herein by reference.

### CROSS REFERENCE TO RELATED APPLICATIONS

The following commonly owned, co-pending United States Patents and Patent Applications, including the present application, are related to each other. Each of the other patents/applications is incorporated by reference herein in its entirety: U.S. patent application Ser. No. 13/275,164 entitled Method and System for Network Availability Alert, by Scott Kincaid, filed Oct. 17, 2011, Attorney Docket No. 48-65/649US; and

U.S. Provisional Patent Application 60/503,744 entitled NETWORK AVAILABILITY ALERT, by Scott Kincaid, filed Jul. 1, 2011 (Attorney Docket No. 649PROV).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to network computing.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Users often require access to network resources. To access network resources, the users are usually required to input a user name and password. At times, however, the user inputs that information and the login fails. There could be a number of reasons for the failure. For example, the user may have input the wrong user name or wrong password. Often a user is provided with a notice or alert that the user entered the wrong name or password. In some cases, the user may be notified that the caps lock is on which could result in the wrong user name and/or password if either is case sensitive. Unfortunately, when there is no network connectivity, there typically is no message indicating that the user is not connected to a network. Usually, a user inputs the user name and password and receives a message indicating the name or password is wrong, misleading the user into believing that the problem is in the password or user name, rather than the network connection.

Accordingly, it is desirable to provide techniques enabling an alert to let user's of the database system know that there is no network availability.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is an operational flow diagram embodiment of a technique for a network availability alert;

FIG. 2 is an operational flow diagram embodiment of a technique for a network availability alert;

FIG. 3 is a block diagram of an embodiment of a system for a network availability alert;

FIG. 4 is a screen shot of an example of a user interface screen for providing a network availability alert;

FIG. 5 is a screen shot of an example of a user interface screen for providing a network availability alert;

FIG. 6 illustrates a block diagram of an example of an environment wherein an on-demand database service might be used;

FIG. 7 illustrates a block diagram of an embodiment of elements of FIG. 6 and various possible interconnections between these elements;

FIG. 8 illustrates a flow diagram of an embodiment of a method of assembling a network availability alert; and

FIG. 9 illustrates a flow diagram of an embodiment of a method of implementing a network availability alert.

### DETAILED DESCRIPTION

Systems and methods are provided for methods and systems for network availability alerts. The network availability alerts provide information about whether a login failed due to a network connectivity problem. In this way, the user may identify why a login screen is not functioning properly. In some embodiments, the methods include sending an algorithm to the user system that allows the system to identify whether the network is connected.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. In an embodiment, the each tenant of the multitenant database is provided usage of a portion of the database on demand (that is, as service to the tenant), so that the tenant has usage of the database, but does not need to worry about maintaining the database. The tenant may have its own employees, representatives, and/or customers that also have use of, and/or interact with, the tenant's portion of the database as a result of being associated with the tenant as determined by the tenant. As used herein, the term query plan refers to a set of steps used to access information in a database system.

The following detailed description will first describe methods and systems for network availability alerts in accordance with aspects and embodiments of the present invention, embodiments of screenshots are then detailed. Following the description of the screenshots, methods of assembling and methods of implementing the network availability alerts are described.

### Server Side Method

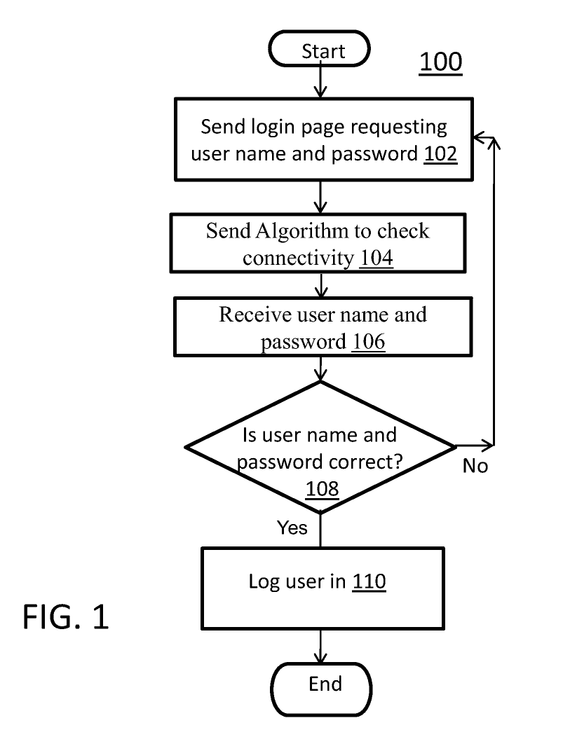

FIG. 1 shows a flowchart of an embodiment of a server-side method 100 of uploading a method for checking network availability and providing an alert. In step 102, the server system receives a request to login. In step 104, the server system sends an algorithm to the user system for checking connectivity (e.g., availability) of the network to the user system. At the same time or, in addition, the server system may also send an algorithm for checking whether the caps lock is on. In step 106 server system receives a user name and/or login. In step 108, the server system checks to see if the user name and password are correct. If the user name and password are not correct, the server system may resend the login page requesting the user password name and password, and/or send a message telling the user that the user name or password is incorrect (the user name and/or password). Alternatively, the server system may provide a help message to help the user to identify the problem and/or provide an email address to request a new user name and/or password. If the user name and password are correct, the server system may log the user in (step 110). In some embodiments, each time the user opens the login web page, the algorithm is sent. In some embodiments, the login page allows access to multiple sites within the database. In an embodiment, each of the steps of method 100 is a distinct step. In another embodiment, although depicted as distinct steps in FIG. 1, steps 102-110 may not be distinct steps. In other embodiments, method 100 may not have all of the above steps and/or may have other steps in addition to or instead of those listed above. The steps of method 100 may be performed in another order. Subsets of the steps listed above as part of method 100 may be used to form their own method.

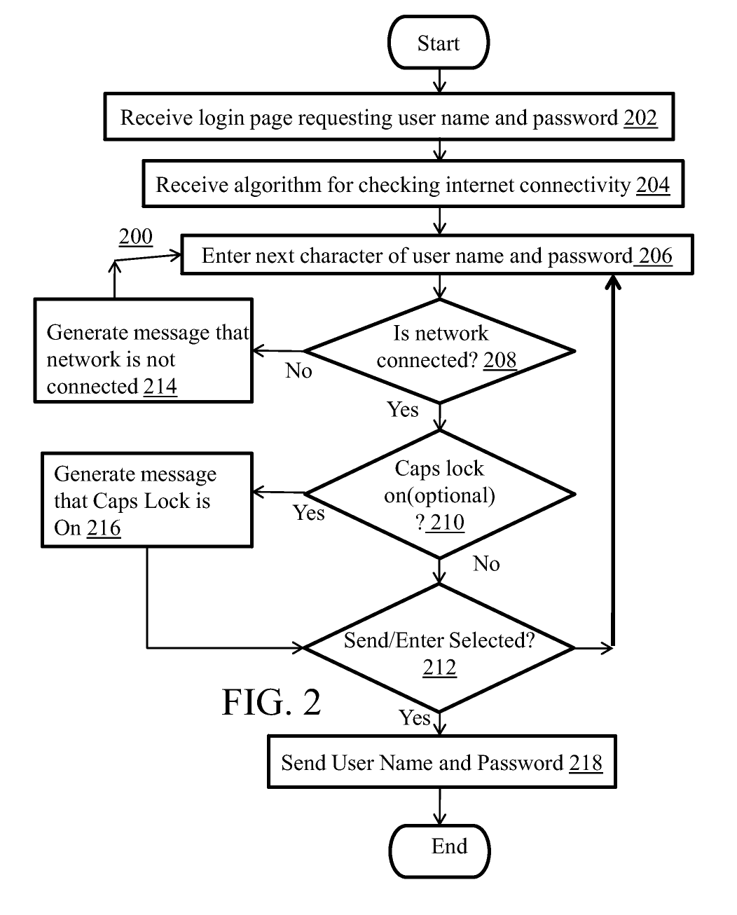

FIG. 2 shows a flowchart of an embodiment of a client-side method 200 of sending a network availability alert. In step 202 a login page is received by the user system from server system requesting the user name and password. In step 204 an algorithm is received at the user system for checking internet connectivity (availability). In step 206, the next character of the user name and/or password is entered. In step 208, the user system invokes the algorithm to see if the network is connected using the algorithm received from the server system. In an embodiment, the internet connectivity is checked after every key stroke. However, in other embodiments, the internet connectivity is checked before, after, and/or during entering a key stroke. In some embodiments, connectivity may be checked after each enter key selection. In some embodiments, connectivity is checked continuously or at intervals during the time the user is on the web page. In some embodiments, each time the user logs in, connectivity is checked.

Because the user name and/or password may be case sensitive, a user may receive a message that the entry is incorrect if the caps lock is on. For this reason, optionally, in an embodiment, if the network is connected, the user system may check to see if the caps lock is on using the algorithm received from the server system in step 210. If the caps lock is on, a message may be generated on the screen stating that the caps lock is on.

In step 212 the user system may “send/enter” the user name and password. If the user system has not sent or entered the user name and password, the user may return to step 206 to enter the next character of the user name and password 206.

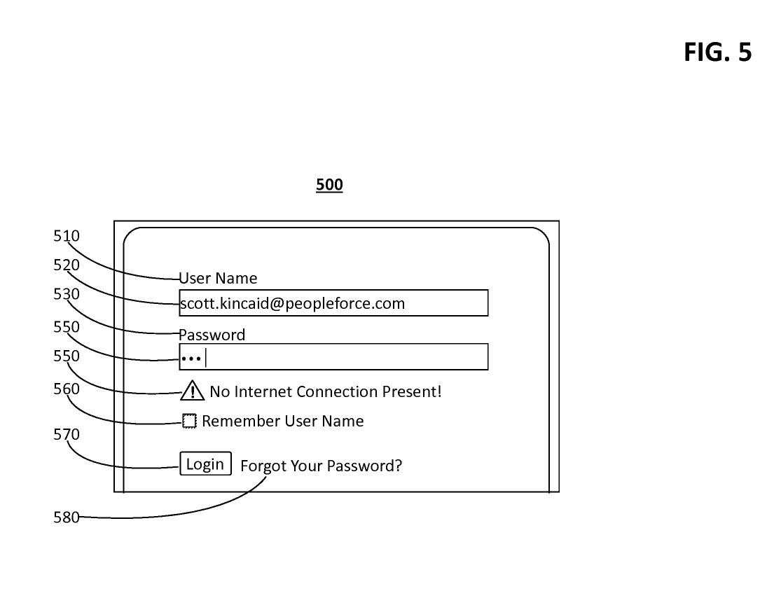

In step 214, if the network is not connected, a message is generated that the network is not connected and the message is presented to the user on the login page 214. A second message may optionally be generated to appear on the screen allowing the user to recheck network availability after a period of time has elapsed and/or after connectivity is restored (an embodiment allowing the user to check to see if the connectivity has been restored is discussed below in conjunction with FIG. 5).

If the caps lock is on, in step 216 a message is generated that the caps lock is on.

If the user has selected the “send/enter” to send the user name and password, in step 218 the user name and password may be sent for login to the server system.

In an embodiment, each of the steps of method 200 is a distinct step. In another embodiment, although depicted as distinct steps in FIG. 2, steps 202-218 may not be distinct steps. In other embodiments, method 200 may not have all of the above steps and/or may have other steps in addition to or instead of those listed above. The steps of method 200 may be performed in another order. Subsets of the steps listed above as part of method 600 may be used to form their own method.

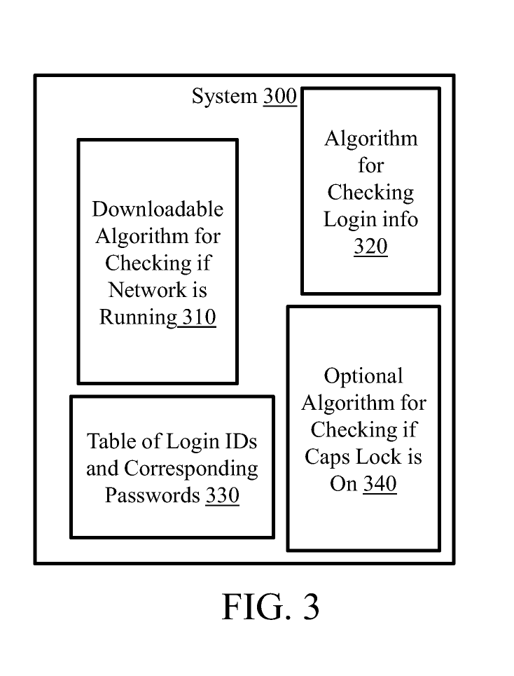

FIG. 3 shows a block diagram of an embodiment of a system for a network availability alert 300. System 300 may include a network check algorithm 310, a login info algorithm 320, one or more tables of login information 330, and an optional caps lock algorithm 340. Login IDs may be user names and/or email addresses. In other embodiments, system 300 may not have all of the elements listed and/or may have other elements instead of, or in addition to, those listed.

In an embodiment the network check algorithm 310 is a downloadable algorithm for checking to identify whether the network is running by sending a message to the server and setting a timer. If the timer times out, prior to receiving the acknowledgement, it is assumed that there is no internet connectivity and an alert is sent. Alternatively, the network check algorithm 310 may identify the frequency at which messages arrive from the internet. For example, an internet connection is continually bombarded with messages from other machines connected to the Internet. Many may be viruses, pop-ups, or just random messages that may not have been targeted to the user's machine. The script in the login application may cause the user machine to monitor the frequency of these messages. If the frequency at which the messages arrive drops below a certain threshold, it is assumed that there is no internet connectivity.

Embodiments of login info algorithms 320 include one or more algorithms for checking login information and may include any algorithm known to the skilled artisan that involves checking a user name and/or password. In some embodiments, the login information algorithm 320 involves checking tables of known user names and passwords (see 330) to identify whether a specific user name is associated with a specific password.

Embodiments of tables of login information 330 may include tables of login user names and the corresponding passwords. The tables of login information 330 may include searchable tables associating specific user names with specific passwords. Other embodiments may use other methods of associating passwords and user names.

In some embodiments, the system may include optional caps lock algorithm 340 for checking whether the caps lock is on the user's machine. This caps lock algorithm 340 may be sent to the user system or optionally may be activated from the server.

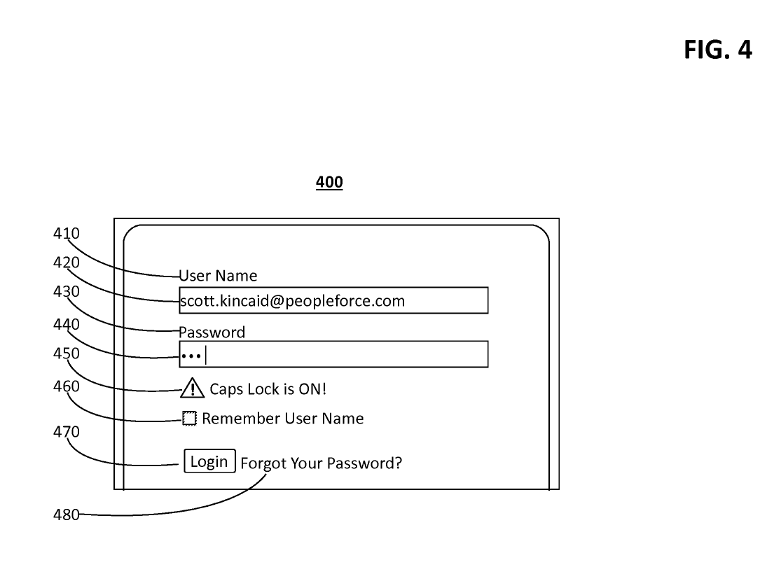

FIG. 4 is a screen shot illustrating an example user interface 400 for providing a network availability alert in an embodiment. The user interface 400 may include a user name label 410, user name box 420, password label 430, for password box 440, caps lock message 450, remember box 460, login button 470, and help link 480. In other embodiments, user interface 400 may not have all of the elements listed and/or may have other elements instead of, or in addition to, those listed.

In an embodiment, user interface 400 is an optional part of (e.g., a different webpage of) user interface 300. The user name label 410 is a label for a box for entering a user name. The username label 410 may be any label that makes it clear to the user that the user should enter the user name in the area designated for entering the user name. Username box 420 is for entering a user name, which is labeled with the user name label 410. The username box 420 may be provided in a shape and size such that the user may enter the entire user name. In some embodiments, in and embodiment, username box 420 may be labeled “email address” instead or in addition to having other labels indicating that the user needs to enter a username.

In some embodiments, the password label 430 may be included with a separate box for entering a password. The password label 430 may be any label that makes it clear to the user that the user should enter the password in the area designated for receiving the password. The password box 440 may be provided in a shape and size such that the user may enter the entire password. Password box 440 may be labeled with password label 430. In some embodiments, the password box 440 may also be include an activatable label “hint” in case the user needs some more information about what the password might be.

FIG. 4 shows an embodiment in which a caps lock message 450 is sent to the user stating that the caps lock is on. The caps lock message 450 may include a label such as “caps lock is ON!” and/or include an icon to get the user's attention, such as an amber exclamation mark.

In some embodiments of the user interface 400 an activatable remember box 460 is provided to help the user remember the user name and/or password. The remember box 460 may include an activatable box and/or message. The remember box 460 may be labeled with any information that makes it clear that by activating the remember box 460 the username will be automatically filled in by the user's machine when the user opens/downloads the login page. For example, remember box 460 may labeled “Remember user name.”

In some embodiments, a login button 470 may be provided for activating the login after the user has completed entering the login information and may be labeled “Login.”. The login button 470 may also be labeled in any way that clarifies that the user should click on and/or select the login button 470 after the user has entered the long information (the password and username), and is ready to login.

In some embodiments, help link 480 may allow the user to get help if for example the user does not remember the user password. In case the user does not remember the password associated with the user name, a help label 480 may be provided for the user to get help finding and/or remembering the password. This help link 480 may include an explanation such as “Forgot your password?” which, when accessed, may give information about the password or how the user may request the password associated with the user name.

FIG. 5 is a screen shot illustrating an example user interface 500 for providing a network availability alert in an embodiment 500. The user interface 500 may include a username label 510, username box 520, password label 530 password box 540, nonconnectivity alert 550, remember username box 560, login button 570, and help link 580. In other embodiments, user interface 500 may not have all of the elements listed and/or may have other elements instead of, or in addition to, those listed.

User interface 500 may be part of (e.g., a different webpage of) user interface 300 and/or 400. Username label 510, username box 520, password label 530, password box 540, remember box 560, login button 570, and help link 580 may be an embodiment of username label 510 for a box may for entering a user name 520, a password label 430, password box 440, a remember box 460, an login button 470, and a help link 480, respectively, which were discussed above in conjunction with FIG. 4, and consequently, that explanation will not be repeated here.

FIG. 5 shows an embodiment in which a message 550 is sent to the user stating that there is no Internet connection—when the user's machine is disconnected from the internet. The message 550 may include a label such as “No Internet connection present!” and/or include an icon to get the user's attention, such as an amber exclamation mark shaped as a triangle. In some embodiments, interface 500 may also include a box that allows the user to recheck internet connectivity, e.g., a box with a message such as “Recheck connectivity”. Some embodiments of the screen shot 500 may also provide the user with a box or label to activate that may give the user help in identifying why there is no connectivity, such as “help in identifying connectivity problems” that may be downloaded with the network check algorithm (see FIG. 3).

### System Overview

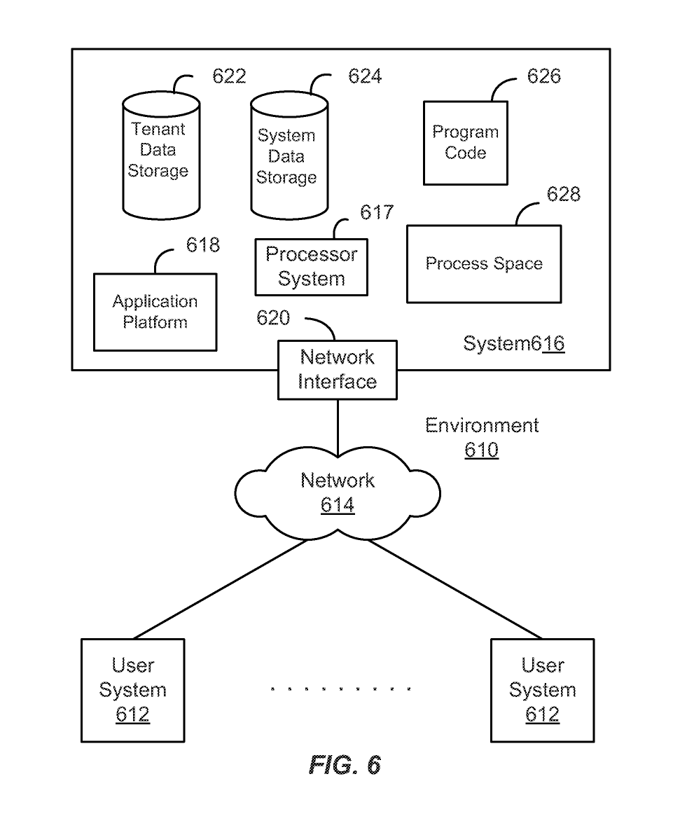

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

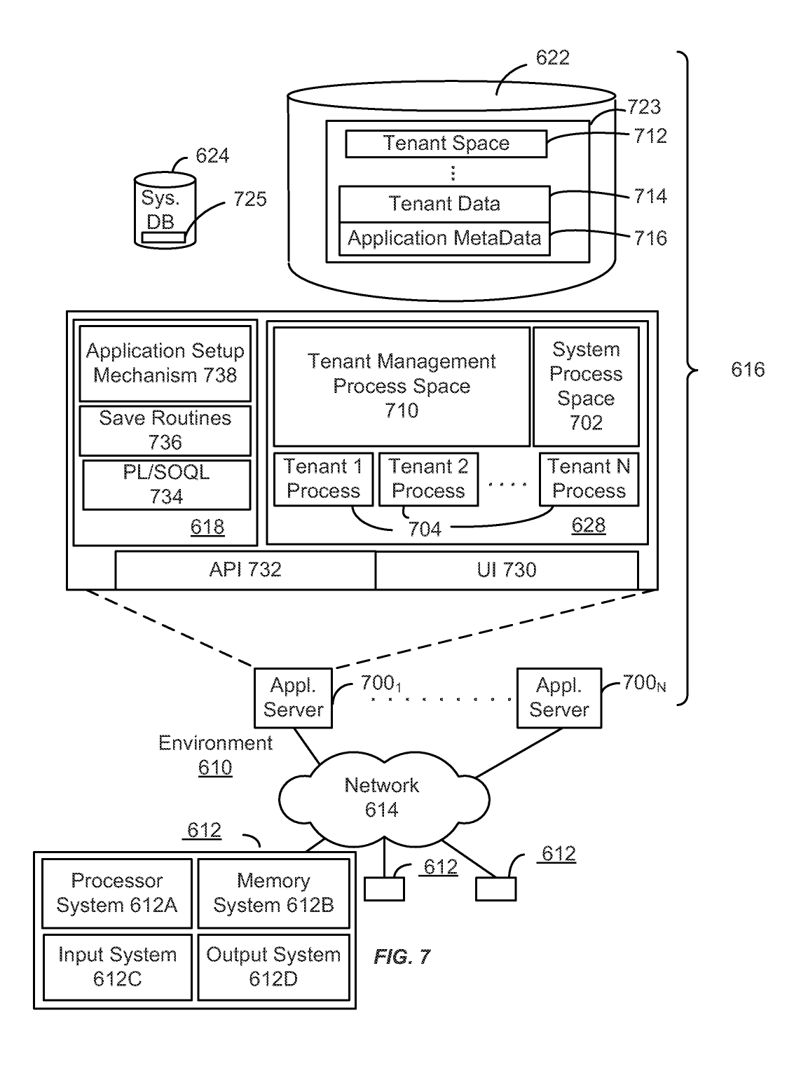

Environment 610 is an environment in which an on-demand database service exists. User system 612 may be any machine or system that is used by a user to access a database user system. For example, any of user systems 612 may be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a pre-established database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). System 616 may be an embodiment of the server system referred to in FIGS. 1-5. Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device may be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of

the present invention may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 723, system data storage 624, system data 725, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant space (storage area) 712, tenant data 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 714 therein, and system data storage 624 and the system data 725 therein to serve requests of user systems 612. The tenant data 714 might be divided into individual tenant storage areas 712, which may be either a physical arrangement and/or a logical arrangement of data. Within each tenant space (storage area) 712, tenant data 714 and application metadata 716 might be similarly allocated for each user. For example, a copy of a user's most recently used (MRU) items might be stored to user storage 612. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 725 and tenant data 714, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700.

In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also may be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., may be maintained and accessed by a user system having nothing more than network access, the user may manage his or her sales efforts and cycles from any of many different user systems. For example, if a salesperson is visiting a customer and the customer has Internet access in their lobby, the salesperson may obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database may generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Creating the Environment (FIGS. 6 and 7)

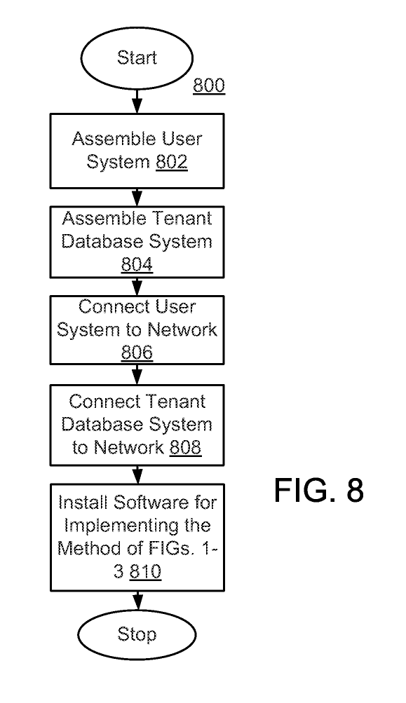

FIG. 8 is a method of making environment 610. In step 802, user system 612 (FIGS. 6 and 7) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 804, system 616 (FIGS. 6 and 7) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 616 may include installing application platform 618, network interface 620, tenant data storage 622, system data storage 624, system data 725, program code 726, process space 728, UI 730, API 732, PL/SOQL 734, save routine 736, application setup mechanism 738, applications servers 700₁-700_{N}, system process space 702, tenant process spaces 704, tenant management process space 710, tenant space 712, tenant data 714, and application metadata 716 (FIG. 7).

In step 806, user system 612 is communicatively coupled to network 704. In step 808, system 616 is communicatively coupled to network 704 allowing user system 612 and system 616 to communicate with one another (FIG. 7). In step 808, the tenant database system is connected to the network. In step 810, one or more instructions may be installed in system 616 (e.g., the instructions may be installed on one or more machine readable media, such as computer readable media, therein) and/or system 616 is otherwise configured for performing the steps of methods for a network availability alert. For example, as part of step 810, one or more instructions may be entered into the memory of system 616 for a network availability alert.

In another embodiment, although depicted as distinct steps in FIG. 8, steps 802-810 may not be distinct steps. In other embodiments, method 800 may not have all of the above steps and/or may have other steps in addition to, or instead of, those listed above. The steps of method 800 may be performed in another order. Subsets of the steps listed above as part of method 800 may be used to form their own method.

### Method for Using the Environment (FIGS. 6 and 7)

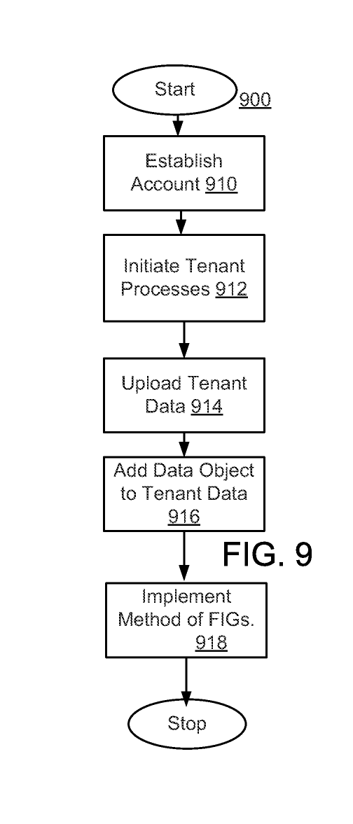

FIG. 9 shows a flowchart of an example of a method 900 of using environment 610. In step 910, user system 612 (FIGs. 1 And 2) establishes an account. In step 912, one more tenant process spaces 704 (FIG. 7) are initiated on behalf of user system 612, which may also involve setting aside space in tenant space 712 (FIG. 7) and tenant data 714 (FIG. 7) for user system 612. Step 912 may also involve modifying application metadata to accommodate user system 612. In step 914, user system 612 uploads data. In step 916, one or more data objects are added to tenant data 714 where the data uploaded is stored. In step 918, methods (FIGS. 1 and 2) may be implemented. In another embodiment, although depicted as distinct steps in FIG. 9, steps 902-918 may not be distinct steps. In other embodiments, method 900 may not have all of the above steps and/or may have other steps in addition to, or instead of, those listed above. The steps of method 900 may be performed in another order. Subsets of the steps listed above as part of method 900 may be used to form their own method.

### EXTENSIONS AND ALTERNATIVES

Each embodiment disclosed herein may be used or otherwise combined with any of the other embodiments disclosed. Any element of any embodiment may be used in any embodiment.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method comprising:
receiving, at a host system of an on-demand multitenant database, a request to logon from a tenant's system, the on demand multitenant database having a processor system including one or more processors and a storage system; and
sending over a network by the processor system a code to check whether the network is connected, the code, when invoked by the tenant's system causes one or more processors of the tenant's system to perform a method including at least
the tenant system determining whether the network is connected to the user system, and
if the network is not connected, the tenant system generating a message indicating that the network is not connected.

2. The method of claim 1, further comprising:
receiving a user name and password; and
determining whether the user name and password is correct; and
if it is determined that the user name and password are correct and that the network is running, allowing the tenant's system access to the on-demand multitenant database.

3. The method of claim 1, further comprising:
sending by the processor system an algorithm to check whether the caps lock is on, wherein if the caps lock is on, the user will receive a message indicating that the caps lock is on.

4. The method of claim 1, further comprising: providing an indicator that the user may activate for the algorithm to recheck whether the network is connected.

5. The method of claim 4, wherein the indicator is a “check now” button.

6. The method of claim 1, wherein the determining whether the network is connected to the user system occurs after the user types a letter or hits “enter.”

7. The method of claim 6, wherein the determining occurs after the user types another letter or hits “enter.”

8. The method of claim 1, further comprising determining whether the network is connected to the user system continuously while the user is connected to the logon page.

9. A machine-readable medium carrying one or more sequences of instructions for identifying whether the network is connected for a user, which instructions, when executed by one or more processors, cause the one or more processors to carry out the steps of: receiving, at a host system of an on-demand multitenant database, a request to logon from a tenant's system, the on demand multitenant database having a processor system including one or more processors and a storage system; and sending by the processor system an algorithm to check whether the network is connected, wherein if the network is not connected, the user will receive a message indicating that the network is not connected.

10. A method comprising:
receiving at a user system from a host system a login page, the login page including a request for a user name and a password, the user system including at least a processor system having one or more processors and a storage system including one or more machine readable media, and a user input device;
receiving at the user system from the host system an algorithm for checking internet connectivity;
receiving one or more characters of login information;
determining, by the processor system, whether the internet is connected to the user system; and
if it is determined that the Internet is not connected to the user system, generating a message for the user indicating that the Internet is not connected.

11. The method of claim 10, further comprising receiving an from the host an algorithm to identify whether the caps lock is on.

12. The method of claim 10, wherein the login page allows the user to recheck Internet connectivity by selecting a button and entering another character of the login information.

13. The method of claim 10, further comprising the generating of the message for the user indicating that the Internet is not connected, receiving another character of input from the user, automatically checking a second time whether the Internet is connected to the user machine.

14. The method of claim 10, further comprising checking the internet is connected at specified times while the user is logged in.
